(19) United States
(12) Patent Application Publication
(10) Pub. No.: US 2010/0332412 A1
(43) Pub. Date: Dec. 30, 2010

(54) METHOD AND SYSTEM FOR VIRTUAL STOCK TRADING ON NETWORKS

(75) Inventor: Jin-Soo PARK, Seoul (KR)

Correspondence Address: HARNESS, DICKEY, & PIERCE, P.L.C, 7700 Bonhomme, Suite 400, ST. LOUIS, MO, 63105, US

(73) Assignee: AJI Inc. d/b/a ZooDak, San Ramon, CA (US)

(21) Appl. No.: 12/825,995

(22) Filed: Jun. 29, 2010

(30) Foreign Application Priority Data
Jun. 30, 2009 (KR) 10-2009-0059520

(51) Int. Cl. G06Q 40/00

(52) U.S. Cl. 705/36 R; 705/37

(57) ABSTRACT

A system for virtual stock trading on the networks comprises a main database (DB) including a user DB and a stock price DB; a stock price provision server for receiving information on real-time stock prices from the stock market on the networks and transmitting the information on real-time stock prices to the main DB; a stock order server receiving information on the orders; and a stock trading server for receiving the information on the stock prices from the stock price provision server, determining whether to execute the transaction of the stocks by using the information on the orders received from the stock order server and providing the information on the transaction of the stocks to the main DB.

### CROSS-REFERENCE TO RELATED APPLICATIONS

This application claims the priority of Korean Patent Application No. 10-2009-0059520 filed on Jun. 30, 2009, in the Korean Intellectual Property Office, the disclosure of which is incorporated herein by reference.

### FIELD

The present disclosure generally relates to a method and system for virtual stock trading. More specifically, the disclosure relates to a method and system for virtual stock trading on the networks allowing users to participate in the virtual stock trades

### BACKGROUND

In recent years, a variety of economic activities using internet communication networks have been accelerated with a sudden increase in internet users, including a stock trade using the internet. In this case, the stock trade using the internet adopts a stock trading system in which a user uses his/her own computer at home or office to access computer networks with which the stock companies contact through the internet, check information on individual stock items, and select a particular stock item from the stock items to trade the stocks at a real-time price. However, the execution of the stock trades without any prior knowledge may lead to economic loss. To prevent economic loss and realize the actual practice of the stock trades, websites for the virtual stock trades have appeared online and many web sites have been managed at home and abroad.

Korean Patent No. 356069 describes a method of simulation stock investment in internet. The method includes constructing a web site using a computer for controlling websites for virtual stock trades by means of the internet network, the website being configured to include a membership subscription space, a stock information space and a stock trading space, and providing a user with a predetermined amount of cyber money for the stock trades when the user uses his/her own user terminal, which has been connected through the internet communication network, to join the website as a member through the membership subscription space; providing the user with information by displaying the information on a screen of the user terminal when the user selects and goes to the stock information space; making a contract using a predetermined amount of cyber money as the stock security when the user determines the period and price applying the futures trading system in respect to the particular stock items at the stock trading space; and transacting repurchase or resale when the users who make a contract in the futures trading system requests the repurchase or resale within a given time. However, investors have less interests and focusing since virtual stock items are traded after the listing of the stock items.

Korean Patent Publication No. 10-2004-0084469 describes a stock trading method using internet network and a system thereof. The system includes a history server for receiving a request for buy order-related information from a user terminal, requesting data from a corresponding server and retransmitting the data to the user terminal; and a stock order server for registering the request for buy order-related information received from the history server, transmitting the results of the request, receiving data of the current transaction prices from a front-end processor to execute a transaction contract for the corresponding stock items and informing information on the executed transaction contract of the corresponding user terminal. The system acts to enable virtual stock trades in connection with actual stocks and allot gains to the members who earn investment returns. However, the order is determined at the price determined in the real market in the most recent years. That is, when a user takes the order, the transaction price is based on the stock prices the users see, but the stock prices presented to the users are the past stock prices.

When a user places a buy order at the actual stock market, the transaction of the stocks is executed with the changes in the current price. In the case of the above-mentioned patent, the transaction of the stocks is executed at the price determined at or before the point of time when the user places the buy order. As a result, although the current prices are changed by the buy order placed by the user or the buy orders placed by the other users, the buying of the stocks is executed at the previous price without reflecting changes in the current prices.

In effect, since the buying of the stocks may not be executed at the corresponding prices due to the changes in the current prices by these buy orders and the stock prices may suddenly change by other causes, the stock trading method is unrealistic. In particular, when the stock prices fluctuate within a short period of time, there is a huge difference between the buy/offer prices and the current prices, which adversely affect the reality of the virtual stock trading. Although the huge difference may not affect the ideal reality of the virtual stock trading, there is an urgent demand to develop methods for virtual stock trading that actually reflects the changes in the stock prices at the real stock market.

Also, the conventional virtual stock trading methods trade stocks at the most current stock prices after the requests for the buy/sell orders, retrieving past data because the trading engine takes a request for the most current stock prices when the order is placed by requesting data from the clients. Alternatively, the trading engine can periodically take requests for information on stock prices until it receives new stock trading data, thus generating a large number of requests for the stock trades to be processed from the clients and leading to a high burden on the system. To address the above-mentioned problems, the trading engine can be configured to receive stock prices with a delay of about 10 to about 15 minutes, which does not overcome systematic delay in stock price information retrieval.

### SUMMARY

The present disclosure provides a method and system for virtual stock trading on the networks capable of trading the stocks using a variety of strategies by forming information on the transaction of the stocks with the reflection of the actual changes in the real stock prices and composing a plurality of portfolios, thereby allowing users to participate in the virtual stock trades.

In various embodiments, there is provided a system for virtual stock trading on the networks. The system may comprise a main database (DB) including a user DB containing private information on users and information on the users' stock trading portfolios and a stock price DB containing information on the stock prices according to the course of time, information on the orders of the individual stock items and information on the transaction of the stocks, and providing the user with information on the stock price DB whenever the user requests; a stock price provision server for receiving information on real-time stock prices from the stock market on the networks and transmitting the information on real-time stock prices to the main DB; a stock order server receiving information on the orders including a buy order, a sell order, a correction order and a cancel order for the individual stock items from users connected through the networks and providing the information on the orders to the main DB; and a stock trading server for receiving the information on the stock prices from the stock price provision server, determining whether to execute the stock transaction by using the information on the orders received from the stock order server and providing the information on the transaction of the stocks to the main DB.

By comparing the point of time when the user takes a request for the information on the orders received from the stock order server with the point of time when the stock prices of the stocks received from the stock price provision server are determined, the stock order server may be configured to determine whether to execute the transaction of the stocks using a forward looking strategy based on the stock prices after the request for the information on the orders.

In an embodiment, the stock trading server is configured to receive information on a transaction volume of the stocks from the stock price provision server and executing the transaction of the stocks within the transaction volume of the stocks.

In an embodiment, the stock price provision server is configured to provide the main DB with the information on the stock prices at a particular time even without any of the requests from the main DB.

In an embodiment, the system may further comprise a ranked server. The ranked server may be configured to receive users' portfolios from the main DB to calculate the gains according to the tournaments, arrange the portfolios according to the order from the portfolios having higher gains and compensate for the gains on the basis of the gain rate.

In an embodiment, the compensation point is calculated according to the following equation:

If PV>PV_{X1} then ZP=(PV_{X20}−PV_{X1})/RT

wherein ZP is the compensation point, PV is the portfolio value, X1 is the initial trading date, and X20 is final trading date.

In an embodiment, the system further comprises an analyst server. In this case, the analyst server may be configured to select, as analysts, users who set the fluctuation of the stock prices of the individual stock items to a constant rate, buy the prediction of the analysts for the fluctuation of the stock prices and give the point when the prediction of the analysts is accurate.

In an embodiment, the analyst server comprises an instantaneous comparison module for searching a stock price DB in the main DB to calculate the value of the users' portfolios from the past and current stock prices; an analogous portfolio extraction module for extracting other users having portfolios, which are analogous to those of the users, from the main DB; and a stock trading adviser extraction module for proposing, as the stock trading advisers, the users who earn higher gains in the engagement with the analogous portfolio extraction module and the instantaneous comparison module. In this case, the analyst server may further include a portfolio public offering module for public offering information on the portfolios of the stock trading advisers to other users in a real-time manner with the stock trading advisers' permission.

In an embodiment, the portfolio is used to determine whether the users pay their participation fees during a given period of time when the tournaments are under way and determine which tournament the users participate in on the basis of the first time when the users make the portfolios.

In another embodiment, there is provided a method for virtual stock trading on networks. The method comprises registering a stock portfolio composed of buy stock items and numbers by participating in a virtual stock trading tournament which is under way for a given period of time and paying an admission fee to the virtual stock trading system using the network (registration step); allowing the prices of the buy stock items in the stock portfolio to fluctuate according to the information on the stock prices provided in a real-time manner after the registration step and providing the users with the fluctuation of the prices of the buy stock items (stock price fluctuation step); changing the portfolios according to the information on the orders connected with the stock price fluctuation step, when there are a buy order, a sell order, a correction order and a cancel order to determine whether to execute the transaction of the ordered stocks by matching the users' buy orders with the information of the stock prices provided in real-time, wherein the transaction of the stocks is determined by using the information of the stock prices received right after the point of time when the users place the buy orders (portfolio changing step); and evaluating the value of the portfolio after a particular point of time (paying step).

In an embodiment, the method further comprises choosing a winner by paying a portfolio dividend for the portfolios participating in the tournament, the portfolios being registered during the given period of time of the tournament.

In some embodiments, a plurality of portfolio are made by each user.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 shows a configuration of a system according to an exemplary embodiment;

FIG. 2 shows an order processing method according to an exemplary embodiment;

FIG. 3 shows a tournament system according to an exemplary embodiment;

FIG. 4 shows the payment after the tournament according to an exemplary embodiment;

FIG. 5 illustrates the concept of analysts according to an exemplary embodiment; and

FIG. 6 illustrates the compensation for the prediction of a platinum analyst.

### DETAILED DESCRIPTION

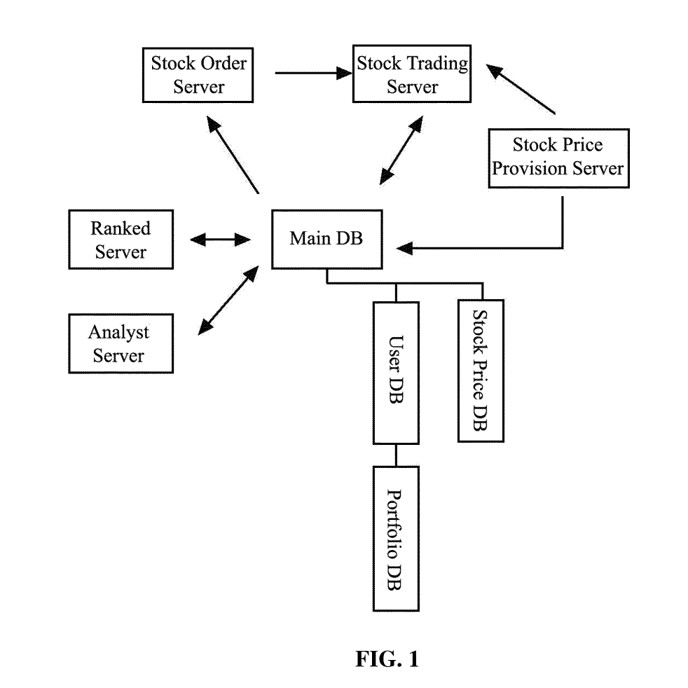

Hereinafter, exemplary embodiments of the present disclosure are described in detail with reference to the accompanying drawings. FIG. 1 shows a portion of a system according to an exemplary embodiment. This embodiment comprises a stock price provision server for receiving data of the stock prices inputted from the outside and supplying data of stock prices to other modules; a stock order server for taking orders which users send through the web; a stock trading server for executing the stock transaction using the orders received from the users and the data of stock prices received from the stock price provision server; a main DB for storing all the data of stock prices received from the stock price provision server and statements of the stock transaction received from the stock trading server; and a ranked server for giving marks to the users participating in the virtual stock trades from the contents of the main DB and determining the user rankings. The system according to an exemplary embodiment may further comprise a user DB for obtaining the users' admission and storing information on the users; and a log-in server for taking charge of log-ins of the users.

The stock price provision server is configured to continuously receive and store the current prices from the stock market. Here, the stock market providing the current prices is applicable to any of markets such as the Korean Securities Dealers Automated Quotations (KOSDAQ), the New York Stock Exchange (NYSE), the National Association of Securities Dealers Automated Quotations (NASDAQ), etc.

When orders are taken from users as previously described, system performance deteriorates because current data of desired stock items and stock transactions after the time of the orders are periodically required in response to the orders. According to the present disclosure, however, the data are continuously received from the stock market in real-time, stored in memory, and transferred to the stock trading server. Since the stock trading server selects the data required for the conclusion of the stock transaction to determine the conclusion/non-conclusion of the transaction of the stocks, the stock trading server requires additional data of the stock prices, leading to deteriorated system performance. The delay is necessarily caused because data are not directly received from the stock market but are received through the stock companies. There is no need to process orders in real-time because orders are processed based on data from before the order was placed.

The stock price provision server sends data of the stock prices to the main DB, so that the main DB can generate data of daily, weekly, monthly and minute candlesticks in a time-series based on the above-mentioned data, and provide the data of the candlesticks to users when requested. The data of the stock prices may include a transaction volume, an order quantity, an order backlog, a sell backlog, a buy backlog, a transaction backlog of the individual stock items, etc.

The main DB includes a user DB containing basic information of users, and the user DB includes a portfolio DB containing the contents of portfolios made by the users and a real-time stock price DB for storing real-time stock prices sent from the stock price provision server, and functions to store information on the trades, orders and transactions according to the stock prices, and assemble a variety of information sent from the other servers and store the information. Also, the user DB includes a log-in DB for allowing users, who participate in the system according to the present disclosure, to log in to the system; and an authentication DB for authenticating whether the users who gain access to the system through the network are registered users, or whether the orders placed by the users are placed by the registered users.

The stock order server functions to take new orders such as buy/sell orders, correction and cancel orders from the users and transmit the new orders to the stock trading server and the main DB. In this case, the main DB stores the information on the orders piled up according to the stock items and transmits the information on the orders according to the stock items to the users at a given time interval.

The stock trading server determines whether to execute the transaction of the ordered stocks by using buy/sell orders, correction and cancel orders of the users received from the stock order server, and other orders through the data of the stock prices received from the stock price provision server. Since several users place orders for the same stock items at the same price, orders must be stored sequentially in a queue to preferentially process the orders placed first by the users.

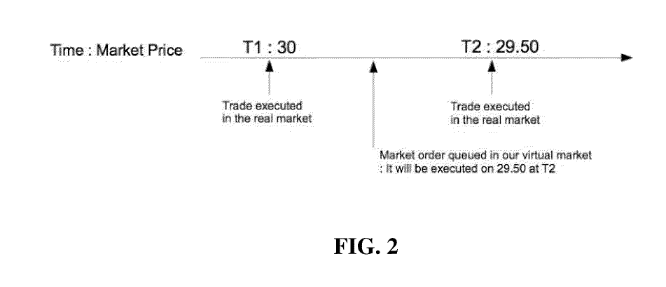

The method of processing orders at the stock trading server is mainly divided into two looking strategies. One of them is a backward looking strategy, which previously described. This backward looking strategy is used to process the order at the most current, last stock prices when orders are placed by users. That is, the method is used to process orders based on stock prices presented when the users place the orders. FIG. 2 shows a state of this system according to the present disclosure. First, when a stock price of a particular stock item is 30 dollars at a time T1, this datum is sent to users who participate in the virtual stock trade, and the users place orders based on the datum. Then, a stock price is changed to 29.50 dollars at the next point of time (T2). When the orders placed by the users are processed based on stock prices at time T1, for example, the stock price of the most current, last stock prices, a point of time when the users see results is time T2. Since the stock price is changed to 29.50 dollars, the users may see results that are different from the actual results. In particular, the stock price is changed according to the law of demand and supply, but the selling stocks may be in effect executed at a time from T1 to T2. Since the orders placed by the users are processed based on time T1, buy orders can be processed. This method may unfortunately run counter to the law underlying the stock market, called the price fluctuations according to the law of demand and supply.

One or more users can place orders for buy/sell backlogs and actual transaction volume of the stocks exceeding the volume stocks traded at the real stock market. In this case, these orders are processed at time T1, but are not processed based on actual transaction volume of the stocks. On the other hand, when the orders are processed based on transaction volume of the stocks at time T1, the order is processed based on past transaction volume of the stock. Therefore, one cannot say that orders are processed in real-time. Accordingly, only orders placed according to the past stock price at the real stock market are considered, although this placing of the orders does not completely mimic the real stock market.

The present disclosure provides a forward looking strategy used to process orders placed by users based on data of the newly introduced stock prices at time T2. The users may predict the stock prices at the next point of time based on stock prices at time T1 and trade stocks. However, this forward looking strategy may not completely mimic the stock market according to the law of demand and supply because current prices fluctuate partly in response to user's buy/sell orders. Since the buy/sell orders in the virtual stock trades may not affect the actual stock market, the actual stock market cannot be mimicked completely, but the forward looking strategy may still closely approximate the actual stock market and consecutively follow the changes in the stock price as in the actual stock market.

When the users place buy/sell orders, the stock trading server stores the buy/sell orders placed by the users in a queue, depending on the traded stock items and their stock prices, and then determines whether to execute the stock transactions in view of the stock prices and transaction volume of the stocks at the next point of time, which are received from the stock price provision server after the next point of time.

The stock transaction is executed in the order of the users queued within a transaction volume of the stocks, which are newly introduced in respect to a buy offer price higher than the current prices of the stocks received from the stock price provision server, and a sell offer price lower than the current price. The stock transaction can effectively be executed within a transaction volume of the stocks, but players who participate in the virtual stock trade are smaller in number than the players at the real stock market. Therefore, the stock transaction may be executed within the transaction volume of the stocks only. For example, in case an actual transaction volume of a certain stock item accounts to about 1000 stocks, the total transaction volume of the stock traded by the players participating in the virtual stock trade may be adjusted to about 300 stocks (about 30%). Although stock transactions may be executed using the backward looking strategy, the stock transactions may not be often executed using the forward looking strategy. The stock transaction has been executed at websites (e.g., updown.com, umoo.com, etc.) for virtual stock trading in U.S. by means of the backward looking strategy, and patents filed in Republic of Korea are also based on the backward looking strategy and have no problems about the forward looking strategy.

The orders may be processed using a variety of strategies. A market order is processed based on data received after the orders are requested, no stocks are traded at the real stock market, and then there are no orders placed by the players. A “limit order” refers to an order placed at a price higher or lower than a certain stock price on buying and selling the stocks. A stop-loss order is divided into two orders: one order for suspending the buying of the stocks when the stock price increases to a price level higher than the stop-loss price, and the other for suspending the selling of the stocks when the stock price decreases to a price level lower than the stop-loss price.

The stock order server functions to receive new buy/sell orders and correction and cancel orders and transmit the information on the orders to the main DB and the stock trading DB to allow users who gain access to their systems through the internet to participate in the virtual stock trade.

The ranked server calculates the gains in respect to the portfolios of users who participate in the virtual stock trade, grades the users for their gains, and divides the reward on the basis of the users' gains. The final results are transmitted to the main DB, and then forwarded to users upon users' request.

The analyst server asks users to predict whether the stock prices of the certain items are increased or decreased or asks users to ask the question, appoints as platinum analysts the users having a high percentage of correct answers, and enables the other users to buy the prediction of the platinum analysts. The analyst server asks a question to select platinum analysts, calculates the percentage of the correct answer and transmits the calculated percentage to the main DB.

The analyst server comprises an instantaneous comparison module for searching a stock price DB in the main DB to calculate the value of the users' portfolios from the past and current stock prices; an analogous portfolio extraction module for extracting other users having portfolios, which are analogous to those of the users, from the main DB; and a stock trading adviser extraction module for proposing, as the stock trading advisers, the users who earn higher gains in the engagement with the analogous portfolio extraction module and the instantaneous comparison module. The analyst server may further comprises a portfolio public offering module for public offering information on the portfolios of the stock trading advisers to other users in a real-time manner with the stock trading advisers' permission.

The analogous portfolios may be judged with the analogy of the individual stock items, and also be judged with the analogies of the classification, themes and prices of individual stock items.

Also, the analyst server selects users who are ranked at a high level in the past and current tournaments and allows common users to read portfolios of the selected users, thereby enabling common users to refer to the portfolios for stock trading. For this purpose, the analyst server may extract, compare and analyze the assigned portfolios from the portfolios of the users selected as the analysts. To select the analysts who publicly offer their portfolios, the analyst server may further comprise a statistics processing module for receiving the data of the analyst's tournaments from the user DB and the tournament DB in the main DB and paying for the tournaments.

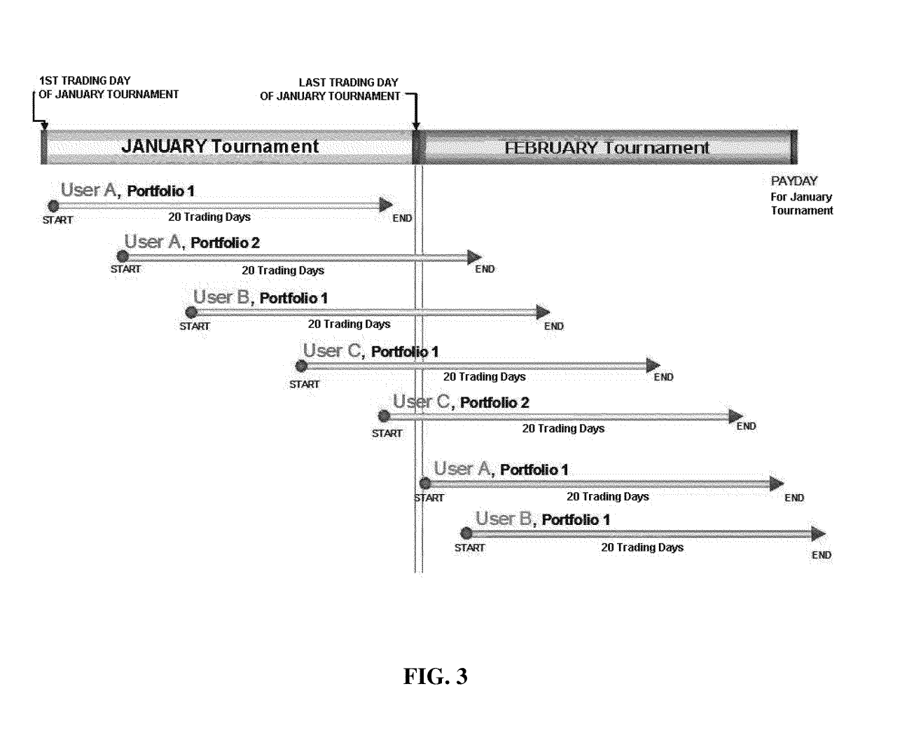

FIG. 3 shows that a virtual stock trading is executed by the system according to the present disclosure. The virtual stock trading tournament according to an exemplary embodiment may be held on a cycle of one month or a given day, but is held on a monthly cycle for convenience' sake.

The users who participate in the virtual stock trade do not pay their participation fee and receive a certain amount of money for the purpose of the virtual trading of the stocks, but they should pay their participation fee for their stock buying portfolios. That is, when users want to manage a plurality of portfolios, they should pay their participation fee for the plurality of portfolios. Previously, users receive a participation fee in every identification to trade the stocks with game money, but they could manage only one portfolio. However, a variety of strategic approaches are applicable to the present disclosure by managing a plurality of portfolios.

In particular, an operating day is limited to about 20 days per portfolio, and all the portfolios introduced during the period of time of the corresponding tournament are considered to participate in the tournament on the basis of the day when the players participate in the tournament. For example, user A manages two portfolios, user B manages one portfolio, and user C manages two portfolios, as shown in FIG. 3. Users A, B and C participate in the same tournament since a January tournament is initiated. The payday for the January tournament is set to the next day (commonly the last day of the next month) after the date when the trading day of the portfolios introduced in January is completed. User A may plan a variety of strategies based on this pay strategy and constitute a plurality of portfolios according to the strategies, and the user C participates in the tournament but makes mistakes. As a result, user C may correct the mistakes, or apply another strategy to the corresponding tournament on the basis of experience from the mistakes. Although a player may judge that there is a favorable factor for a particular stock around the last day of February, the player may not trade the corresponding stock when he/she participates in the tournament in January. Therefore, it is effective for the player to participate in the tournament at the last day of January. The cash reward may be doubled since it is awarded to the players according to the portfolios, and the management of the plurality of portfolios leads to an increased income for an operator.

Unlike previously when a player uses only one his/her own identification to execute the virtual trade during a certain period of time, a player may manage a plurality of portfolios and participate in the corresponding tournament during the tournament period. The player can employ a variety of strategies according to the limit to the period of time and the diversity of the portfolios, since he/she can guarantee a certain period of the trading day. The present disclosure is not limited thereto, but the participants in the tournament pay are not judged based on the point of time of the portfolios, but when the finishing date of the trading of the portfolios is within the payday, the participants in the tournament pay may be judged on the basis of the closest payday to the finishing date. Other modifications and changes may also be made herein.

The number of the portfolios which are individually managed by the players is limited to approximately 10 portfolios. The players may manage about one portfolio without any participation fee, and the awarding may be limited to mileages or points.

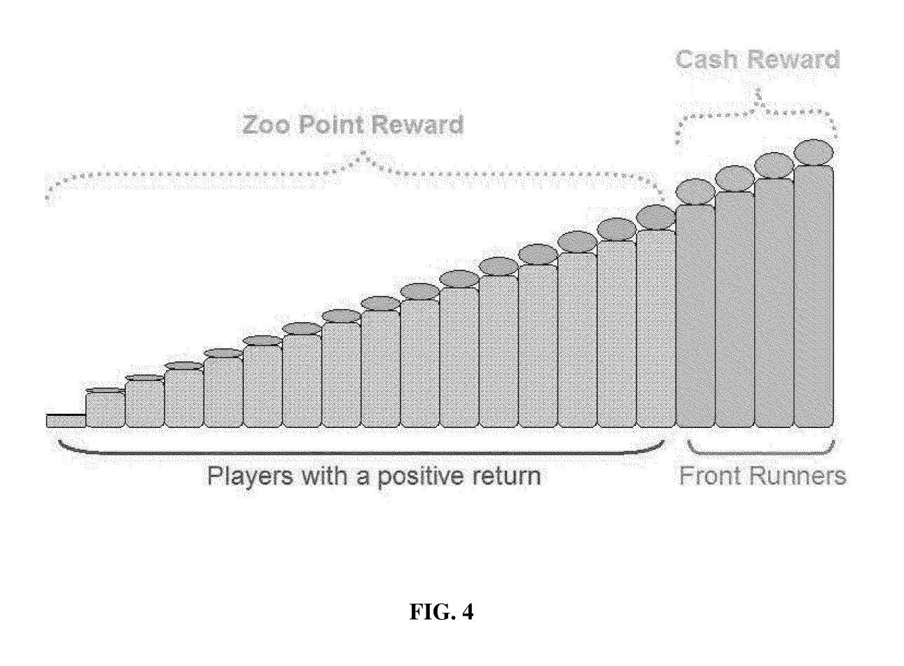

FIG. 4 shows one example of the payment. The return per portfolio may be calculated and sorted in a queue. The portfolios ranked at a high level can be compensated with money and the portfolios ranked at a level lower than the portfolios ranked at the high level can be sequentially compensated with points according to the gain rate. The present disclosure is not limited thereto, the dividends of the higher rankers can also be increased instead of compensating for the higher rankers with points/mileages. The ranked server may be configured to announce the reward at the starting date of the tournament and display the ranking of the portfolios which are compensated with cash. The returns for the lower rankers are measured by the following equation. The portfolios having money lower than the first staring money is not awarded, but may be compensated for with the points as much as the increased value of the portfolios:

If PV>$100,000, then ZP=(PV_{X20}−PV_{X1})/RT

where ZP is the compensation point, PV is the portfolio value, X1 is the initial trading date, X20 is the final trading date, and RT is the transfer rate.

The tournament may be divided into two tournaments: one tournament in which cash is awarded as the reward; and the other in which cash is awarded as the points. In the former, RT may be set to about 100 instead of receiving a participation fee for the portfolios as cash, and RT may be set to about 200 for the tournament in which cash is awarded as the points.

For the conventional stock trades, the portfolios ranging from a first place to a certain place are awarded cash, gift cards and the like, but the portfolios ranked at a place lower than the certain place are not awarded at all. According to the present disclosure, when the value of the portfolios is increased in sum, a portfolio, ranked at the last place is also awarded in proportion to the increased value of portfolios. Therefore, since any of the portfolios participate in the virtual stock trade without giving up to the last, the keen competition can be facilitated to the end. The virtual stock trading system according to the present disclosure may induce the use of the points earned through the virtual stock trading system by linking with separate shopping systems.

Payment for the tournament is made on a given payday, and the ranking is determined according to the income earned per portfolio.

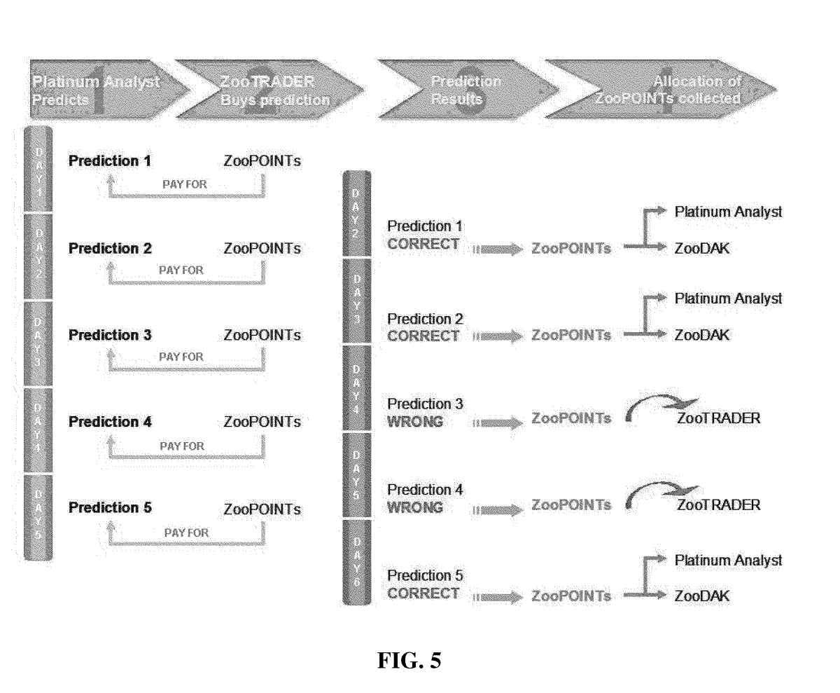

FIG. 5 illustrates the concept of analysts according to one exemplary embodiment of the present invention. According to the present disclosure, the analysts predict which individual stock items show their fluctuation in stock prices at the next day. To see what the analysts' prediction of the analysts is, users can buy the prediction by giving additional points to the analysts. When the prediction is accurate the day after buying the prediction, the corresponding points are distributed to the analysts and central operating bodies. When the prediction is not accurate, the bought points are paid back to the buyers. The analysts who make the prediction are called platinum analysts and encourage the ranked server to ask about the fluctuation in the stock prices of individual stock items to users every day or encourage the users to ask the question. The users having a high percentage of correct answers may be appointed as the platinum analysts to encourage common users to buy the prediction of the platinum analysts.

The common users can read the portfolios of the platinum analysts. Since stock trading beginners can determine which stock items the users want to buy and how many users want to trade stocks, the common users should execute the stock trade with reference to the stock trade of the platinum analysts to give the index for the stock trade. For this purpose, the analyst server comprises an analyst selection module for selecting analysts; and an instantaneous comparison module for evaluating the value of the analysts' portfolios from the current stock prices referencing the portfolio DB of the analysts in the main DB. The analyst selection module comprises a hit rate calculating module for predicting a stock price of a certain stock item and calculating a prediction hit rate of the stock price, and can comprise an analyst extraction module for evaluating the value of the user's past portfolios and extracting the users having a high gain rate at the tournament; and a stock trading adviser extraction module for extracting other users having a high gain rate in the portfolios which are analogous to those of the current users and allowing the user to public-offer the changes in the portfolios to stock trading beginners in real-time to guide whether the users become stock trading advisers for the stock trading beginners. The stock trading adviser or the analysts may be compensated with some of the gains of users whom they advise, or with additional points.

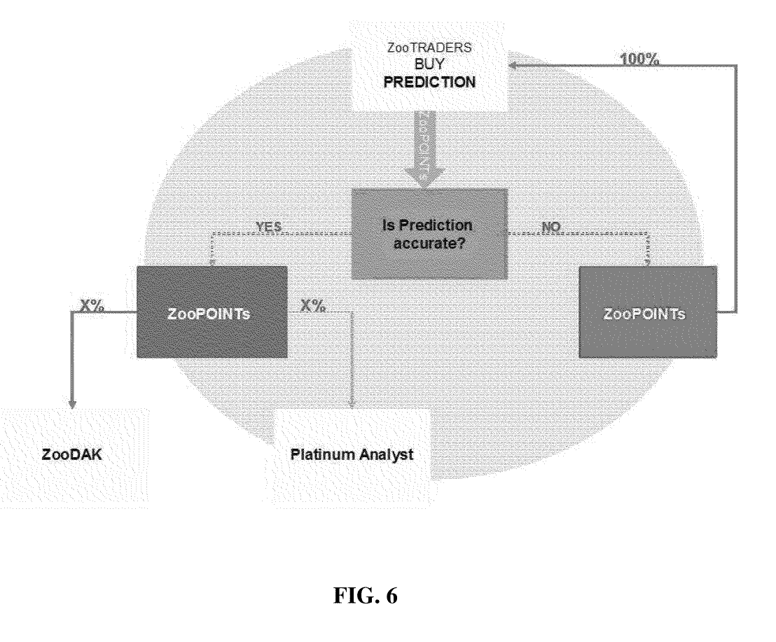

FIG. 6 shows the compensation for the prediction of platinum analysts.

As described above, the system and method for virtual stock trading according to the present disclosure may be useful to provide the virtual stock trading system which completely reflects the changes in real-time stock transactions and participate in the virtual stock trades using a variety of the strategies.

While the present disclosure has been shown and described in connection with the exemplary embodiments, it should be understood that the prefixes such as “zoo-” terms used in the specification, drawings and appended claims should be construed to be peculiar to the applicant of the present disclosure. It will be apparent to those skilled in the art that modifications and variations can be made in the present disclosure without deviating from the spirit or scope of the disclosure. Thus, it is intended that the present disclosure cover any such modifications and variations of this disclosure provided they come within the scope of the appended claims and their equivalents. Accordingly, these and other changes and modifications are seen to be within the true spirit and scope of the disclosure as defined by the appended claims.

In the specification, there have been disclosed typical embodiments of the disclosure and, although specific terms are employed, unless noted elsewhere herein, they are used in a generic and descriptive sense only and not for purposes of limitation. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

The terminology used herein is for the purpose of describing particular example embodiments only and is not intended to be limiting. As used herein, the singular “a”, “an” and “the” may be intended to include the plural forms as well, unless the context clearly indicates otherwise. The terms “comprises”, “comprising”, “including”, and “having” are inclusive and, therefore, specify the presence of stated features, integers, steps, operations, elements, and/or components, but do not preclude the presence or addition of one or more other feathers, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A system for virtual stock trading on the networks, comprising:
a main database (DB) including a user DB containing private information on users and information on the users' stock trading portfolios and a stock price DB containing information on the stock prices, the stock price DB containing information on the stock prices according to the course of time, information on the orders of the individual stock items and information on the transaction of the stocks, and providing the user with information on the stock price DB whenever there are requests from the user;
a stock price provision server for receiving information on real-time stock prices from the stock market on the networks and transmitting the information on real-time stock prices to the main DB;
a stock order server receiving information on the orders including a buy order, a sell order, a correction order and a cancel order for the individual stock items from users connected through the networks and providing the information on the orders to the main DB; and
a stock trading server for receiving the information on the stock prices from the stock price provision server, determining whether to execute the transaction of the stocks by using the information on the orders received from the stock order server and providing the information on the transaction of the stocks to the main DB.

2. The system according to claim 1, wherein the stock order server is configured to determine whether to execute the transaction of the stocks using a forward looking strategy on the basis of the stock prices after the request for the information on the orders by comparing the point of time when the user takes a request for the information on the orders received from the stock order server with the point of time when the stock prices received from the stock price provision server is determined.

3. The system according to claim 2, wherein the stock trading server is configured to receive information on a transaction volume of the stocks from the stock price provision server and executing the transaction of the stocks within the transaction volume of the stocks.

4. The system according to claim 3, wherein the stock price provision server is configured to provide the main DB with the information on the stock prices at a certain time even without any of the requests from the main DB.

5. The system according to claim 4, further comprising a ranked server wherein the ranked server is configured to receive users' portfolios from the main DB to calculate the gains according to the tournaments, arrange the portfolios according to the order from the portfolios having higher gains and compensate for the gains on the basis of the gain rate.

6. The system according to claim 5, wherein the compensation point is calculated according to the following equation:
If PV>PV_{X1} then ZP=(PV_{X20}−PV_{X1})/RT
wherein ZP is compensation point; PV is portfolio value: X1 is initial trading date; X20 is final trading date; and RT is the transfer rate.

7. The system according to claim 6, further comprising an analyst server wherein the analyst server is configured to select, as analysts, users who set the fluctuation of the stock prices of the individual stock items to a constant rate, buy the prediction of the analysts for the fluctuation of the stock prices and give the point when the prediction of the analysts is accurate.

8. The system according to claim 7, wherein the analyst server comprises:
an instantaneous comparison module for searching a stock price DB in the main DB to calculate the value of the users' portfolios from the past and current stock prices;
an analogous portfolio extraction module for extracting other users having portfolios, which are analogous to those of the users, from the main DB; and
a stock trading adviser extraction module for proposing, as the stock trading advisers, the users who earn higher gains in the engagement with the analogous portfolio extraction module and the instantaneous comparison module, and
wherein the analyst server further comprises a portfolio public offering module for public offering information on the portfolios of the stock trading advisers to other users in a real-time manner with the stock trading advisers' permission.

9. The system according to claim 7, wherein the portfolios are used to determine whether the users pay their participation fees during a given period of time when the tournaments are under way and determine which tournament the users participate in on the basis of the first time when the users make the portfolios.

10. A method for virtual stock trading on the networks, the method comprising:
registering a stock portfolio comprising buy stock items and numbers by participating in a virtual stock trading tournament which is under way for a given period of time and paying an admission fee to the virtual stock trading system using the network;
allowing the prices of the buy stock items in the stock portfolio to fluctuate according to the information on the stock prices provided in a real-time manner after the registering and providing the users with the fluctuation of the prices of the buy stock items;
changing the portfolios according to the information on the orders in connection with the stock price fluctuation step, when there are a buy order, a sell order, a correction order and a cancel order, so as to determine whether to execute the transaction of the ordered stocks by matching the users' buy orders with the information of the stock prices provided in a real-time manner, wherein the transaction of the stocks is determined by using the information of the stock prices received right after the point of time when the users place the buy orders; and
evaluating the value of the portfolio after a certain point of time.

11. The method according to 10, further comprising choosing a winner by paying a portfolio dividend for the portfolios participating in the tournament, the portfolios being registered during the given period of time of the tournament.

12. The method according to 11, wherein the portfolios are made in the plural number by every user.
